(19) United States
(12) Patent Application Publication
(10) Pub. No.: US 2021/0146816 A1
(43) Pub. Date: May 20, 2021

(54) FOLD UP TABLE FOR A VEHICLE TAILGATE

(71) Applicant: Holger Schanz, Rancho Mission Viejo, CA (US)

(72) Inventor: Holger Schanz, Rancho Mission Viejo, CA (US)

(21) Appl. No.: 16/947,647

(22) Filed: Aug. 11, 2020

Related U.S. Application Data
(60) Provisional application No. 62/863,457, filed on Jun. 19, 2019.

(51) Int. Cl. B60N 3/00; A47B 5/06; B60R 11/00; A47B 3/08; B60P 3/34

(52) U.S. Cl. CPC B60N 3/001; A47B 5/06; B60R 11/00; B60R 2011/0082; B60P 3/34; B60R 2011/004; A47B 3/0818

(57) ABSTRACT

A fold up table for a vehicle tailgate may be attached (aftermarket) or integrated (OEM) into the vehicles tailgate (or in the tailgate area). The tailgate table minimizes or eliminates storage space and is available at any time for instant and convenient use, by just unfolding it for use and refold for storage. The fold up table includes a folding mechanism operatively coupled to a motor vehicle tailgate. The folding mechanism is operable to move a supported tabletop between a stowed and deployed condition.

### CROSS-REFERENCE TO RELATED APPLICATION

This application claims the benefit of priority of U.S. provisional application No. 62/863,457, filed Jun. 19, 2019, the contents of which are herein incorporated by reference.

### BACKGROUND OF THE INVENTION

The present invention relates to motor vehicle accessories, and more particularly to accessories for tailgates of a motor vehicle.

There are various use cases (recreational or professional or other) where having a table around a vehicle comes in handy. A general option would a foldable camping table or some special table that can be attached to a vehicles hitch, but both options require to remember packing the table, and requires space to store the table when not in use, as well as the need to assemble/attach and later disassemble, re-package and re-storage them.

Other portable table options, such as a camping table, requires remembering to pack the table for later use, requires extra space in the vehicle to store, as well as unpacking/assembly with later disassembly and repacking per every usage. Even a table that can be attached to the hitch requires assembly and extra storage space, is cumbersome to lift and attach, and is only usable if there is nothing already hitched to the vehicle.

As can be seen, there is a need for a foldable table that is either attached (aftermarket) or integrated (OEM) into the vehicles tailgate (or in the tailgate area), minimizing (or eliminating) storage space, for any time, instant, and convenient use, simply by unfolding it for use and refold for storage.

### SUMMARY OF THE INVENTION

In one aspect of the invention, A folding mechanism for fold up attachment of a tabletop to a vehicle tailgate is disclosed. The folding mechanism includes an upper bracket that is configured for attachment to a bottom surface of the tabletop. A lower bracket is configured for attachment to the vehicle tailgate. At least one table leg, having a proximal end and a distal end, wherein the proximal end is pivotally attached to the upper bracket and the distal end is pivotally attached to the lower bracket. The upper bracket is selectively positionable between an erect position with the at least one table leg supporting the upper bracket in an upright condition and a stowed position, with the upper bracket, the at least one table leg, and the lower bracket laid flat.

In some embodiments, a fluid strut is operatively connected between the upper bracket and the lower bracket, the fluid strut providing regulated. A ball joint stud may be attached to each of the upper bracket and the lower bracket. A cooperating ball joint socket is disposed at opposed ends of the fluid strut releasably engage with the ball joint stud. In some embodiments, the fluid strut is aligned in an offset orientation to resist a folding of the upper bracket to the stowed position.

In other embodiments, a locking mechanism is configured to retain the upper bracket in the stowed condition. The locking mechanism may further includes a locking plate slidably attached to the lower bracket, a locking hook disposed at a distal end of the locking plate, and a locking tang attached to the upper bracket, wherein in a stowed condition, the locking hook cooperatively engages with the locking tang.

In other embodiments, an elongate slot is defined in a surface of the locking plate; and a plurality of fasteners extend through the elongate slot, such that the locking plate is slidably carried on the plurality of fasteners.

In other aspects, a folding table is adapted for coupling to a tailgate of a motor vehicle. The folding table includes a tabletop. An upper bracket is attached to a bottom surface of the tabletop. A lower bracket is configured for attachment to the tailgate. At least one table leg has a proximal end and a distal end. The proximal end is pivotally attached to the upper bracket and the distal end is pivotally attached to the lower bracket. The upper bracket is selectively positionable between an erect position, with the at least one table leg supporting the upper bracket in an upright condition, and a stowed position, with the upper bracket, the at least one table leg, and the lower bracket laid flat.

In some embodiments, a fluid strut is operatively connected between the upper bracket and lower bracket, the fluid strut providing regulated. A ball joint stud is attached to each of the upper bracket and the lower bracket. A cooperating ball joint socket disposed at opposed ends of the fluid strut to releasably engage with the ball joint stud.

In some embodiments, the fluid strut is aligned in an offset orientation to resist a folding of the upper bracket to the stowed position.

In some embodiments, a locking mechanism is configured to retain the upper bracket in the stowed condition. The locking mechanism may further include a locking plate slidably attached to the lower bracket. A locking hook is disposed at a distal end of the locking plate. A locking tang is attached to the upper bracket, such that in a stowed condition, the locking hook cooperatively engages with the locking tang.

In other embodiments, an elongate slot is defined in a surface of the locking plate. A plurality of fasteners extend through the elongate slot. The locking plate is slidably carried on the plurality of fasteners.

In yet other aspects of the invention, a motor vehicle tailgate is disclosed. The tailgate includes a tabletop. A folding mechanism is attached between the table top and a face of the tailgate. The tabletop is selectively positionable between an erect position, with at least one table leg supporting the tabletop in an upright condition, and a stowed position, with the tabletop positioned atop the tailgate.

In other embodiments, the folding mechanism extends the tabletop rearwardly from and supported above a plane of the tailgate when the tailgate is in a lowered position.

These and other features, aspects and advantages of the present invention will become better understood with reference to the following drawings, description and claims.

### BRIEF DESCRIPTION OF THE DRAWINGS

FIG. 1 is a perspective view of the invention shown in-use;

FIG. 2 is an enlarged perspective view of the invention shown in the deployed position;

FIG. 3 is an exploded bottom perspective view of the invention;

FIG. 4 is a section view taken along line 4-4 from FIG. 2;

FIG. 5 is a partial perspective view of the invention shown in the closed position;

FIG. 6 is a plan view of the invention the table removed for clarity;

FIG. 7 is a section view taken along line 7-7 from FIG. 6;

FIG. 8A is a section view taken along line 8A-8A from FIG. 6, shown in the unlocked position;

FIG. 8B is a section view similar to that of FIG. 8A illustrating the locked position;

FIG. 9A is a section view taken along line 9A-9A from FIG. 6, shown in the unlocked position;

FIG. 9B is a section view similar to that of FIG. 9A illustrating the locked position; and

FIG. 10 is a perspective view shown in-use of the invention on a closed truck tailgate.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provides a system method and apparatus for adapting a motor vehicle tailgate with a selectively retractable and extensible table surface.

The foldable table includes a table top 10 with a folding mechanism that may be either attached to, as in an aftermarket product, or integrated into an OEM vehicle tailgate 44 itself. The foldable table 10 may also be mounted somewhere proximal to the tailgate 44 area of the truck bed 43. The configuration allows the table 10 to become part of the vehicle, making it always and conveniently available, without the need to remember packing it, and requiring no or minimal storage space. The foldable table also requires no assembly/disassembly before or after each usage.

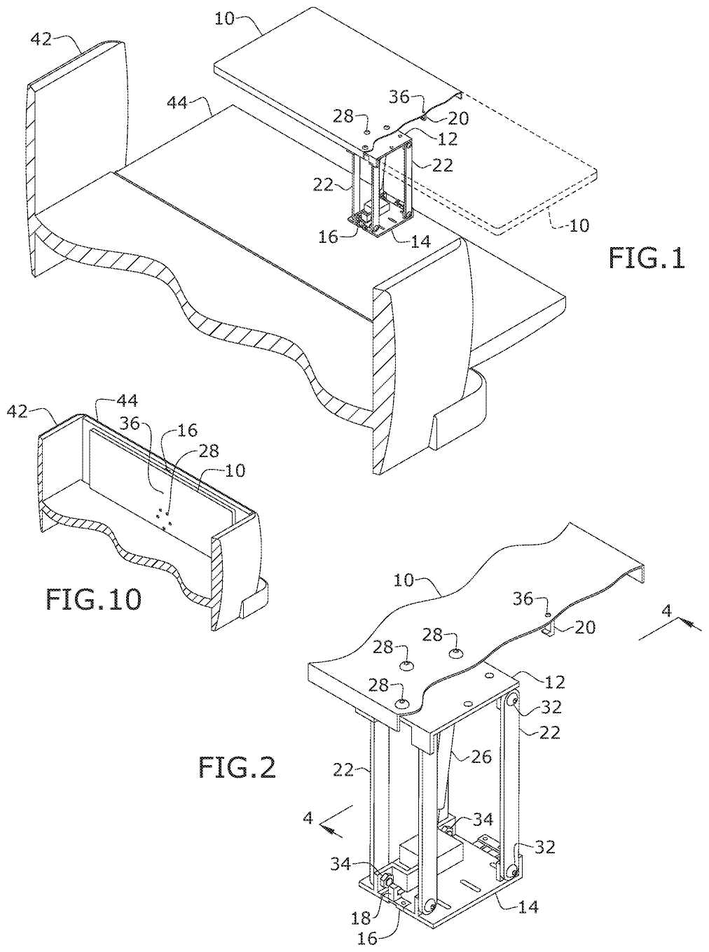

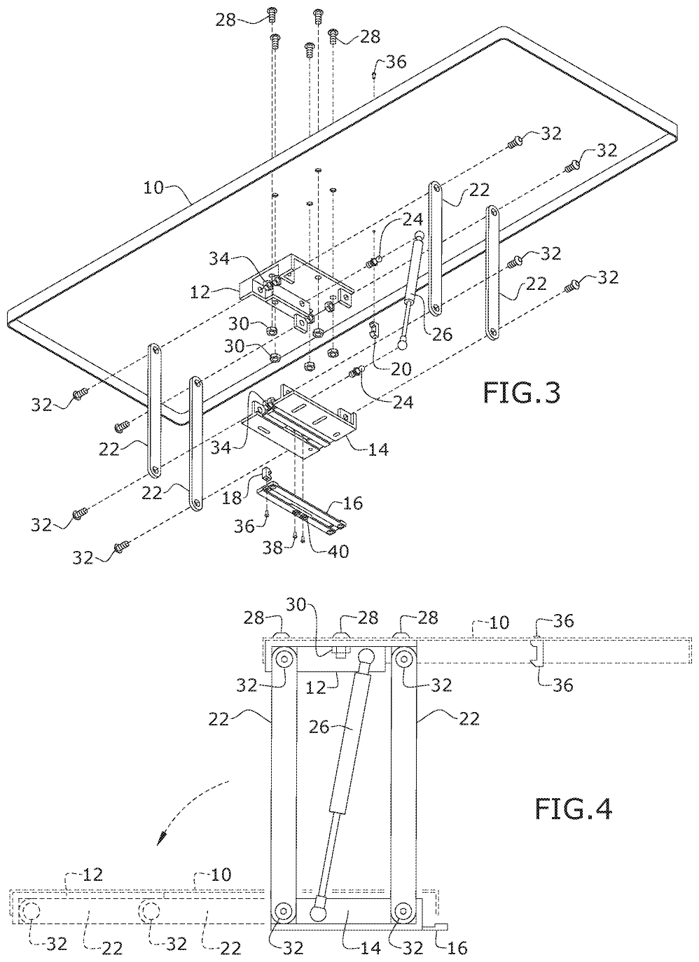

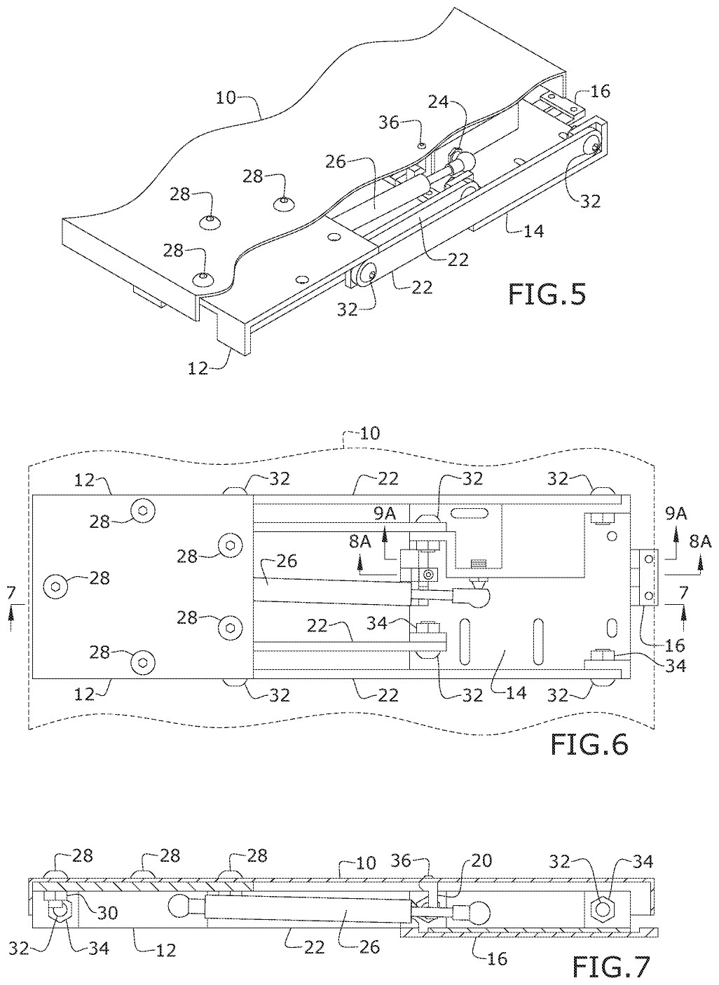

As seen in reference to the drawings of FIGS. 1-10, the folding mechanism has an lower mounting bracket 14, that provides for the direct attachment or integration of the table 10 in or around the tailgate 55 of a vehicle with a plurality of fasteners 28, such as bolts, rivets, or screws. An opposite end of the folding mechanism has an upper mounting bracket 12 that attaches to a table top 10 carried by the folding mechanism. The table top 10 may be substantially rectangular, or may be shaped for specific work activities or a desired decor.

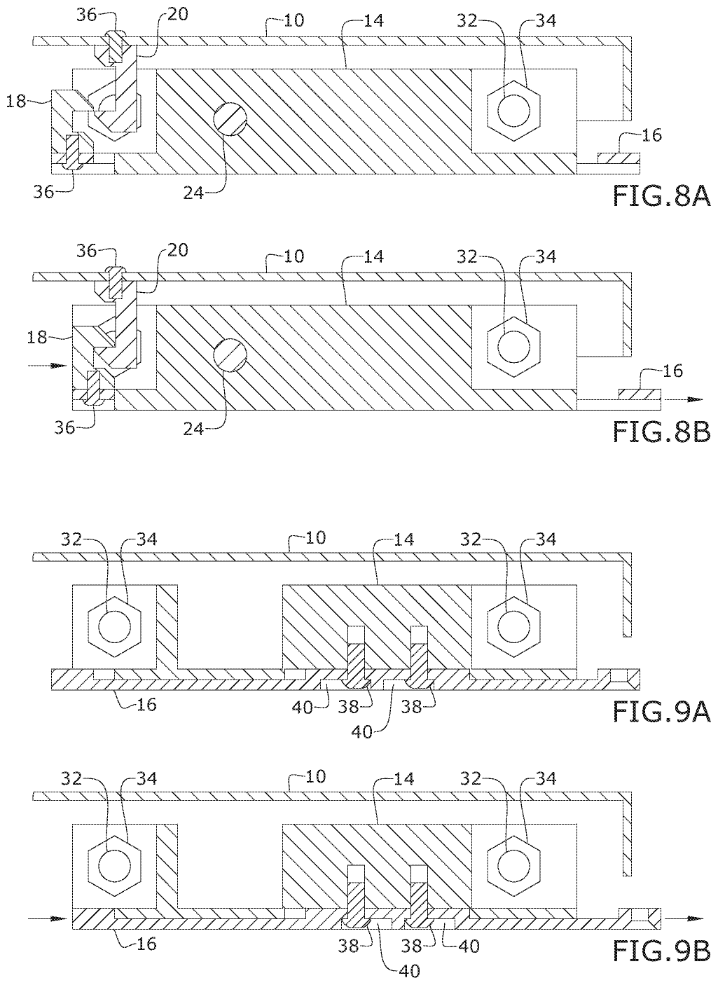

As best seen in reference to FIGS. 8A-9B, a locking mechanism is provided to retain the tabletop in a stowed condition, typically, flush against the tailgate 44. The locking mechanism includes a slide lock plate 16 movable for selective engagement of a slide lock hook 18 at a distal end of the slide lock plate 16 with a table lock tang 20 extending from one of the table top 10 or upper bracket 14 to retain the table top 10 in the stowed position. The slide lock plate 16 is slidably attached to the lower mounting bracket 14. the slide lock plate 16 is operable to release the slide lock hook 18 from the table lock tang 20 to permit the tabletop 10 to be moved into an erected position. The slide lock plate 16 is attached to the lower mounting bracket 14 via a plurality of fasteners 38 received through slotted apertures 40. The slide lock 18 is attached to a distal end of the slide lock plate 16 via a fastener 36, such as a bolt, screw, pin, or rivet.

The folding mechanism includes at least one table leg 22, having a proximal end and a distal end. The proximal end of the at least one table leg 22 is attached to the upper bracket 12 via a fastener, such as a bolt 32 and nut 34, a rivet, pin, or the like. Likewise, the distal end of the at least one table leg 22 is attached to the lower bracket 14 via a fastener, such as the bolt 32 and nut. The attachments of the at least one table leg 22 provide pivot points about which the at least one leg 22 may pivot when moving between one of the stowed and erected positions.

A fluid strut 26, such as a gas lift spring, may be operably coupled between the upper mounting bracket 12 and the lower mounting bracket 14. A ball joint stud 24 is attached to a flange on each of the upper mounting bracket 12 and the lower mounting bracket 14. The ball joint 24 engages with a cooperating ball joint socket on opposed ends of the fluid strut 26. The fluid strut 26 is extensible and provides for regulated movement of the tabletop 10 when being positioned between the erect position and the stowed position. The fluid strut 26 is offset from a vertical alignment, when in the erect position, to facilitate retaining the tabletop 10 in the upright position. Optionally, the folding mechanism can include a spring mechanism, or pneumatic lift strut, to support the weight of the table and allow for easier ('zero effort') deployment and unfolding.

The folding mechanism allows the table top 10 to be folded flat for storage (when not in use) or for the table to be unfolded, providing a flat and sturdy table area 10 above the tailgate 44. This arrangement makes the remaining tailgate/trunk area a convenient seating space. The locking mechanism allows the tabletop 10 to be locked and secured when folded and unfolded, so that it doesn't unfold (fold) accidentally or while the vehicle is used otherwise.

With the foldable table permanently attached (aftermarket) or integrated into (OEM) a vehicles tailgate (or trunk area), the tabletop 10 can be simply unfolded or elevated for usage and later folded or retracted for storage. No further assembly and/or packaging is required and minimal space is wasted while the table is retracted and not in use.

The foldable table of the present invention is conceptualized to be used as a convenient, low profile storage table, primarily in a vehicle tailgate/trunk area. It could very well be used in other areas, e.g. boats, planes or other stationary objects.

It should be understood, of course, that the foregoing relates to exemplary embodiments of the invention and that modifications may be made without departing from the spirit and scope of the invention.

What is claimed is:

1. A folding mechanism for fold up attachment of a tabletop to a vehicle tailgate, comprising:
an upper bracket configured for attachment to a bottom surface of the tabletop;
a lower bracket configured for attachment to the vehicle tailgate;
at least one table leg having a proximal end and a distal end, wherein the proximal end is pivotally attached to the upper bracket and the distal end is pivotally attached to the lower bracket, wherein the upper bracket is selectively positionable between an erect position with the at least one table leg supporting the upper bracket in an upright condition and a stowed position, with the upper bracket, the at least one table leg, and the lower bracket laid flat.

2. The folding mechanism of claim 1, further comprising:
a fluid strut operatively connected between the upper bracket and the lower bracket, the fluid strut providing regulated.

3. The folding mechanism of claim 2, further comprising:
a ball joint stud attached to each of the upper bracket and the lower bracket, and
a cooperating ball joint socket disposed at opposed ends of the fluid strut releasably engage with the ball joint stud.

4. The folding mechanism of claim 2, wherein the fluid strut is aligned in an offset orientation to resist a folding of the upper bracket to the stowed position.

5. The folding mechanism of claim 1, further comprising:
a locking mechanism configured to retain the upper bracket in the stowed condition.

6. The folding mechanism of claim 5, the locking mechanism further comprising:
a locking plate slidably attached to the lower bracket;
a locking hook disposed at a distal end of the locking plate, and
a locking tang attached to the upper bracket, wherein in a stowed condition, the locking hook cooperatively engages with the locking tang.

7. The folding mechanism of claim 6, further comprising:
an elongate slot defined in a surface of the locking plate; and
a plurality of fasteners extending through the elongate slot, wherein the locking plate is slidably carried on the plurality of fasteners.

8. A folding table adapted for coupling to a tailgate of a motor vehicle, comprising:
a tabletop;
an upper bracket attached to a bottom surface of the tabletop;
a lower bracket configured for attachment to the tailgate;
at least one table leg having a proximal end and a distal end, the proximal end pivotally attached to the upper bracket and the distal end is pivotally attached to the lower bracket, wherein the upper bracket is selectively positionable between an erect position with the at least one table leg supporting the upper bracket in an upright condition and a stowed position, with the upper bracket, the at least one table leg, and the lower bracket laid flat.

9. The folding table of claim 8, further comprising:
a fluid strut operatively connected between the upper bracket and lower bracket, the fluid strut providing regulated.

10. The folding table of claim 9, further comprising:
a ball joint stud attached to each of the upper bracket and the lower bracket, and
a cooperating ball joint socket disposed at opposed ends of the fluid strut releasably engage with the ball joint stud.

11. The folding table of claim 10, wherein the fluid strut is aligned in an offset orientation to resist a folding of the upper bracket to the stowed position.

12. The folding table of claim 9, further comprising:
a locking mechanism configured to retain the upper bracket in the stowed condition.

13. The folding table of claim 12, the locking mechanism further comprising:
a locking plate slidably attached to the lower bracket;
a locking hook disposed at a distal end of the locking plate, and
a locking tang attached to the upper bracket, wherein in a stowed condition, the locking hook cooperatively engages with the locking tang.

14. The folding table of claim 13, further comprising:
an elongate slot defined in a surface of the locking plate; and
a plurality of fasteners extending through the elongate slot, wherein the locking plate is slidably carried on the plurality of fasteners.

15. A motor vehicle tailgate, comprising:
a tabletop;
a folding mechanism attached between the table top and a face of the tailgate, wherein the table top is selectively positionable between an erect position, with at least one table leg supporting the table top in an upright condition, and a stowed position, with the tabletop positioned atop the face of the tailgate.

16. The motor vehicle tailgate of claim 15, wherein the folding mechanism extends the tabletop rearwardly from and supported above a plane of the tailgate when the tailgate is in a lowered position.
